(19) United States
(12) Patent Application Publication
(10) Pub. No.: US 2025/0020199 A1
(43) Pub. Date: Jan. 16, 2025

(54) GEAR PAIR

(71) Applicant: MUSASHI SEIMITSU INDUSTRY CO., LTD., TOYOHASHI-SHI, AICHI (JP)

(72) Inventors: Shiryu KATOH, TOYOHASHI-SHI, AICHI (JP); Shinya MATSUOKA, TOYOHASHI-SHI, AICHI (JP)

(21) Appl. No.: 18/699,676

(22) PCT Filed: Oct. 19, 2021
(86) PCT No.: PCT/JP2021/038579

§ 371 Date: Sep. 24, 2024

(51) Int. Cl. F16H 55/08; F16H 1/14

(52) U.S. Cl. CPC F16H 55/0846; F16H 1/14

(57) ABSTRACT

In a gear pair in which a first gear and a second gear having a greater number of teeth than the first gear share a meshing line of teeth that mesh with each other, at least a part of the meshing line includes a region where a pressure angle is not constant, the pressure angle monotonously decreases in a section of the meshing line from a pitch point to an end point on a tooth-top side of the first gear, and a relative curvature of tooth profile curves of the first and second gears in the section of the meshing line from the pitch point to the end point on the tooth-top side of the first gear is smaller than or equal to a maximum value of the relative curvature in a section from the pitch point to an end point on a tooth-root side of the first gear.

### TECHNICAL FIELD

The present invention relates to a gear pair comprising a first gear and a second gear having a larger number of teeth than the first gear.

In the present invention and the present specification, “a meshing line of teeth that mesh with each other” refers to a segment corresponding to a movement trajectory of a contact point (meshing point) of teeth that mesh with each other. An expression “the meshing line is shared” means that the contact point moves continuously on a single continuous meshing line in a process of moving from a start point to an end point of meshing. For example, the expression means that the meshing line does not branch (specifically, the teeth that mesh with each other do not contact simultaneously at two points or more) or is not discontinued (specifically, the contact is not interrupted). Also, “a meshing line length” refers to a length of a segment of the meshing line from the start point of meshing.

In the present specification, “a relative curvature” is defined as a sum of a curvature of a tooth profile curve of one tooth and a curvature of a tooth profile curve of the other tooth at the contact point of the teeth that mesh with each other. The smaller the relative curvature is, the lower the contact stress at the meshing point tends to be, and the higher the tooth surface strength tends to be. Also, the greater the relative curvature is, the longer the meshing length tends to be, and the higher the meshing ratio tends to be. In other words, the tooth surface strength and the meshing ratio have a contradictory relationship with respect to the relative curvature.

### BACKGROUND ART

For defining a tooth profile curve of each gear of a gear pair, there is a technique of connecting a concave part on a tooth-root side and a convex part on a tooth-top side with a transition zone in a specific form, for example, in order to reduce a contact stress at a contact point (meshing point) of teeth that mesh with each other. This technique is conventionally known as disclosed in Patent Document 1, for example.

### PRIOR ART DOCUMENTS

### Patent Documents

Patent Document 1: Japanese Patent No. 4429390

### SUMMARY OF THE INVENTION

### Problems to be Solved by the Invention

In the gear pair of Patent Document 1, however, no consideration is given on how to set a pressure angle in defining the tooth profile curve. It is also not clear whether the gear pair shares the meshing line. Accordingly, sufficient efforts have not been made to smoothly mesh the gear pair and to increase the strength of each tooth.

In a gear pair comprising conventionally known involute gears, since a meshing line of teeth that mesh with each other is a single continuous line from the start point to the end point of meshing (that is, the meshing line is shared), there is an advantage that the meshing is smooth. On the other hand, in the involute gear having a constant pressure angle, attempts to reduce the pressure angle or to increase a tooth height in order to increase the meshing ratio lead to a decrease in the tooth surface strength due to an increase in the tooth surface pressure, and a decrease in a tooth root strength due to an increase in a tooth-root moment.

The present invention has been made in consideration of the above circumstances. An object of the present invention is to provide a gear pair that can solve the aforementioned problems all at once.

### Means for Solving the Problems

In order to achieve the above object, the present invention has a first characteristic that, in a gear pair in which a first gear and a second gear having a larger number of teeth than the first gear share a meshing line of teeth that mesh with each other, at least a part of the meshing line includes a region where a pressure angle is not constant, the pressure angle monotonously decreases in a section of the meshing line from a pitch point to an end point on a tooth-top side of the first gear, and a relative curvature of tooth profile curves of the first and second gears in the section of the meshing line from the pitch point to the end point on the tooth-top side of the first gear is smaller than or equal to a maximum value of the relative curvature in a section from the pitch point to an end point on a tooth-root side of the first gear.

In addition to the first characteristic, the present invention has a second characteristic that the pressure angle weakly increases in the section of the meshing line from the pitch point to the end point on the tooth-root side of the first gear.

In addition, the present invention has a third characteristic that, in a gear pair in which a first gear and a second gear having a larger number of teeth than the first gear share a meshing line of teeth that mesh with each other, at least a part of the meshing line includes a region where a pressure angle is not constant, the pressure angle is constant in a section of the meshing line from a pitch point to an end point on a tooth-top side of the first gear, and the pressure angle monotonously increases in a section of the meshing line from the pitch point to an end point on a tooth-root side of the first gear, and a relative curvature of tooth profile curves of the first and second gears in the section of the meshing line from the pitch point to the end point on the tooth-top side of the first gear is smaller than or equal to a maximum value of the relative curvature in the section from the pitch point to the end point on the tooth-root side of the first gear.

In addition to any one of the first to third characteristics, the present invention has a fourth characteristic that a value obtained by differentiating a curvature of a tooth profile curve by a meshing line length constantly changes in an entire region of the meshing line.

In addition to any one of the first to fourth characteristics, the present invention has a fifth characteristic that the pressure angle is greater than zero (0) degrees in the entire region of the meshing line.

In addition to any one of the first to fifth characteristics, the present invention has a sixth characteristic that the first and second gears are forged bevel gears.

### Effects of the Invention

According to the invention, in the gear pair comprising the first gear and the second gear having the larger number of the teeth than the first gear, the teeth that mesh with each other share the meshing line. Thus, the first and second gears can achieve smooth meshing. Moreover, at least a part of the meshing line includes the region where the pressure angle is not constant. Thus, while the meshing line is shared as above, it is possible to set the pressure angle of the both gears to various modes of change in association with the meshing line, and achieve both desired properties (for example, tooth surface strength) in accordance with the setting, and smooth meshing.

According to the first characteristic, the pressure angle monotonously decreases in the section of the meshing line from the pitch point to the end point on the tooth-top side of the first gear, and the relative curvature of the tooth profile curves of the first and second gears in the section of the meshing line from the pitch point to the end point on the tooth-top side of the first gear is smaller than or equal to the maximum value of the relative curvature in the section from the pitch point to the end point on the tooth-root side of the first gear. In other words, in case of the gear (for example, involute gear) having a constant pressure angle in the entire region of the meshing line, there is a surplus tooth surface strength on the tooth-top side as compared to that on the tooth-root side. Considering this point, the surplus tooth surface strength on the tooth-top side can be used to improve a meshing ratio by reducing the pressure angle on the tooth-top side (thus, increasing the relative curvature). In addition, it is possible to keep the tooth surface strength on the tooth-top side from becoming too low (that is, to ensure that the tooth surface strength on the tooth-top side is greater than or equal to that on the tooth-root side) by setting the relative curvature on the tooth-top side smaller than or equal to the maximum value of the relative curvature on the tooth-root side as in the first characteristic. This makes it possible to increase the meshing ratio while simultaneously ensuring the required tooth surface strength on the tooth-top side. Particularly, the strength can be effectively increased by defining the pressure angle of the gear having the small number of the teeth (that is, the first gear) which is subject to a large load compared to the gear having the large number of the teeth (that is, the second gear) as in the first characteristic.

According to the second characteristic, since the pressure angle weakly increases in the section of the meshing line from the pitch point to the end point on the tooth-root side of the first gear, the relative curvature can be reduced and the tooth surface strength can be increased on the tooth-root side of the first gear. Moreover, when the tooth profile curve nearly has a negative curvature or has a negative curvature on the tooth-root side, the tooth profile expands toward the tooth root. Thus, a bending strength can be increased. Accordingly, the strength on the tooth-root side of the gear having the small number of the teeth (that is, the first gear), which is especially subject to a large load, can be effectively increased.

According to the third characteristic, the pressure angle is constant in the section of the meshing line from the pitch point to the end point on the tooth-top side of the first gear, the pressure angle monotonously increases in the section of the meshing line from the pitch point to the end point on the tooth-root side of the first gear, and the relative curvature of the tooth profile curves of the first and second gears in the section of the meshing line from the pitch point to the end point on the tooth-top side of the first gear is smaller than or equal to the maximum value of the relative curvature in the section from the pitch point to the end point on the tooth-root side of the first gear. In other words, it is possible to increase the meshing ratio by setting the pressure angle to be constant in the section on the tooth-top side while increasing the strength on the tooth-root side of the gear having the small number of teeth (that is, the first gear), which is subject to a large load, by monotonously increasing the pressure angle (thus, reducing the relative curvature). In addition, it is possible to keep the tooth surface strength on the tooth-top side from becoming lower than that on the tooth-root side (that is, to ensure that the tooth surface strength on the tooth-top side is greater than or equal to that on the tooth-root side) by setting the relative curvature on the tooth-top side smaller than or equal to the maximum value of the relative curvature on the tooth-root side. This makes it possible to increase the meshing ratio while simultaneously ensuring the required tooth surface strength on the tooth-root side and the tooth-top side.

According to the fourth characteristic, the value obtained by differentiating the curvature of the tooth profile curve by the meshing line length constantly changes in an entire region of the meshing line. Thus, the relative curvature at the contact point of the teeth that mesh with each other also constantly changes during the meshing. Accordingly, by setting the tooth profile curve that alleviates the change in meshing stiffness of tooth surfaces due to the change in the number of meshing teeth (for example, by reducing a relative curvature of a one-tooth meshing region, and increasing the relative curvature of a two-teeth meshing region), tooth surface deformation due to the Hertzian contact can be used to cancel the change in meshing stiffness, and achieve uniform meshing stiffness over the entire tooth surface.

According to the fifth characteristic, the pressure angle is greater than zero (0) degrees in the entire region of the meshing line. Thus, at the contact point of the teeth that mesh with each other, the relative curvature is relatively small on average, and the tooth surface strength can be increased.

According to the sixth characteristic, the first and second gears are forged bevel gears. Thus, even a complex spherical tooth profile of the bevel gear can be easily and accurately formed by forging.

### BRIEF DESCRIPTION OF THE DRAWINGS

FIG. 1 is a diagram showing a gear pair according to a first embodiment, where (A) shows tooth surfaces and a meshing line of teeth that mesh with each other, (B) shows changes in a pressure angle with respect to a meshing line length, and (C) shows changes in a differential value of a curvature of a tooth profile curve and a relative curvature with respect to the meshing line length.

FIG. 2 is a diagram showing a gear pair according to a second embodiment, where (A) shows tooth surfaces and a meshing line of teeth that mesh with each other, (B) shows changes in a pressure angle with respect to a meshing line length, and (C) shows changes in a differential value of a curvature of a tooth profile curve and a relative curvature with respect to the meshing line length.

FIG. 3 is a diagram showing a gear pair according to a third embodiment, where (A) shows tooth surfaces and a meshing line of teeth that mesh with each other, (B) shows changes in a pressure angle with respect to a meshing line length, and (C) shows changes in a differential value of a curvature of a tooth profile curve and a relative curvature with respect to the meshing line length.

FIG. 4 is an explanatory diagram for explaining the Eular-Savary formula.

FIG. 5 is an explanatory diagram for inducing the Eular-Savary formula.

FIG. 6 is an explanatory diagram for explaining a definition of a pressure angle of a spherical tooth profile in a gear pair according to a fourth embodiment.

### EXPLANATION OF REFERENCE NUMERALS

G1, G2 . . . first and second gears
κ . . . relative curvature
κᵣ . . . relative curvature at an end point on a meshing line on a tooth-root side of the first gear (maximum value of the relative curvature in a section of the meshing line from a pitch point to the end point on the tooth-root side of the first gear in a first embodiment)
κₚ . . . relative curvature at the pitch point on the meshing line (maximum value of the relative curvature in the section of the meshing line from the pitch point to the end point on the tooth-root side of the first gear in second and third embodiments)
L . . . meshing line
Pe1 . . . end point on the meshing line on the tooth-root side of the first gear
Pe2 . . . end point on the meshing line on the tooth-top side of the first gear
Pp . . . pitch point on the meshing line
α . . . pressure angle

### MODE FOR CARRYING OUT THE INVENTION

Embodiments of the present invention will be described hereinafter based on the accompanying drawings.

### First Embodiment

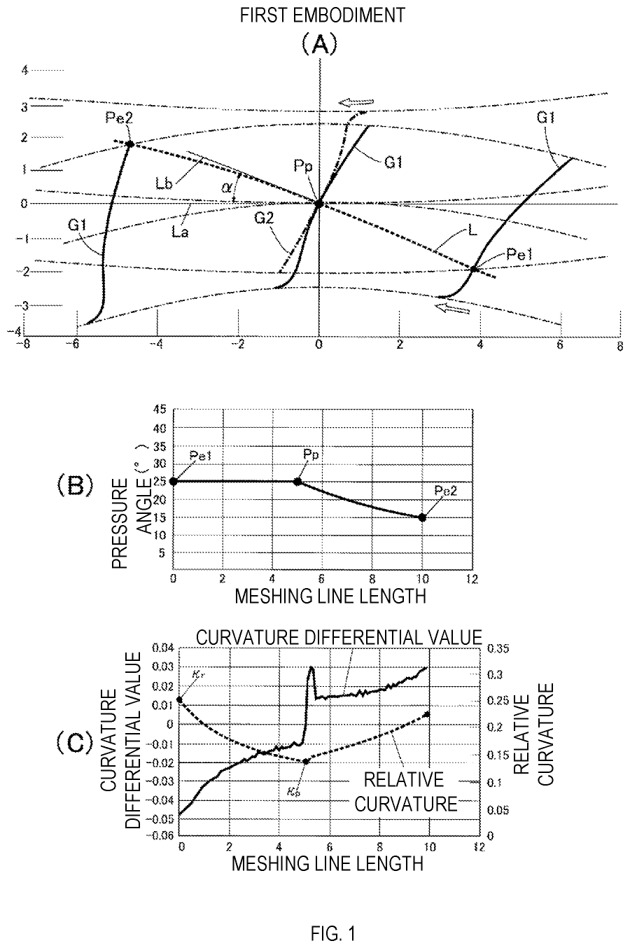

First, a gear pair of the first embodiment will be described with reference to FIG. 1. The gear pair comprises spur gears having rotation axes parallel to each other and is a pair of first and second gears G1, G2 that mesh with each other. Specifically, the first gear G1 on a lower side of part (A) of FIG. 1 is a small diameter gear having a small number of teeth, and functions as a drive gear. The second gear G2 on an upper side is a large diameter gear having a larger number of teeth than the first gear G1, and functions as a driven gear. Which of the first gear G1 having the small number of teeth and the second gear G2 having the large number of teeth is set to be on a drive side or a driven side may be determined as desired.

In addition, part (A) of FIG. 1 shows a meshing mode between tooth surfaces (a thick solid line indicates a tooth surface of the first gear G1, and a thick dash-dotted line indicates a tooth surface of the second gear G2) when a contact point (hereinafter, referred to as a “meshing point”) of teeth of the first and second gears G1, G2 that mesh with each other is located at a pitch point Pp on a meshing line L shown by a thick dotted line, together with the tooth surfaces when the first gear G1 is at a start and an end of meshing.

Tooth surfaces of the first and second gears G1, G2 on the side opposite to the meshing side, which are not shown, are symmetrical in shape to the tooth surfaces on the meshing side in the present embodiment. In part (A) of FIG. 1, the first gear G1 rotates counterclockwise, and the second gear G2 rotates clockwise.

The first and second gears G1, G2 rotate in an engaged manner, and along with the rotation, the meshing point of the teeth that mesh with each other moves continuously. A movement trajectory, that is, the meshing line L is a smooth curve as shown in the thick dotted line in part (A) of FIG. 1. Specifically, the meshing line L of the first and second gears G1, G2 is not a straight line like a meshing line of involute gears. In other words, the first and second gears G1, G2 are not involute gears.

In the gear pair of the present embodiment, teeth of the first and second gears G1, G2 that mesh with each other share the meshing line L.

More specifically, the meshing point of the teeth that mesh with each other moves continuously on the single continuous meshing line L while traveling from a start point to an end point of meshing (that is, from an end point Pe1 on a tooth-root side to an end point Pe2 on a tooth-top side of the first gear G1). That is, the meshing line L does not branch (that is, the teeth that mesh with each other do not contact at two or more points simultaneously) or is not discontinuous (that is, the contact is not interrupted).

In addition, in the gear pair of the present invention, as shown in part (B) of FIG. 1, a pressure angle α is not constant in some region of the meshing line L. Here, the pressure angle α will be explained as follows. In a gear pair having rotation axes parallel to each other, as shown in part (A) of FIG. 1, at any meshing point of teeth that mesh with each other, an angle α of intersection on an acute angle side between a common tangent line La of a pitch circle at a pitch point and a tangent line Lb of the meshing line L at the pitch point is defined as the pressure angle at the meshing point.

In the gear pair of the first embodiment, a mode of change of the pressure angle α with respect to a meshing line length is shown in a thick solid line in part (B) of FIG. 1. That is, the pressure angle α is constant in a section of the meshing line L from the pitch point Pp to the end point Pe1 on the tooth-root side of the first gear G1, and decreases in a section of the meshing line L from the pitch point Pp to the end point Pe2 on the tooth-top side of the first gear G1. Here, the “meshing line length” refers to a length of a segment of the meshing line L from the start point of meshing (specifically, the end point Pe1 on the tooth-root side of the first gear G1), as described above.

Then, as is also clear from part (C) of FIG. 1, in the tooth profile curves of the first and second gears G1, G2 of the first embodiment, a relative curvature κ in the section of the meshing line L from the pitch point Pp to the end point Pe2 on the tooth-top side of the first gear G1 is smaller than or equal to a maximum value of the relative curvature κ in the section from the pitch point Pp to the end point Pe1 on the tooth-root side of the first gear G1 (that is, a relative curvature κᵣ at the end point Pe1 on the tooth-root side of the first gear G1).

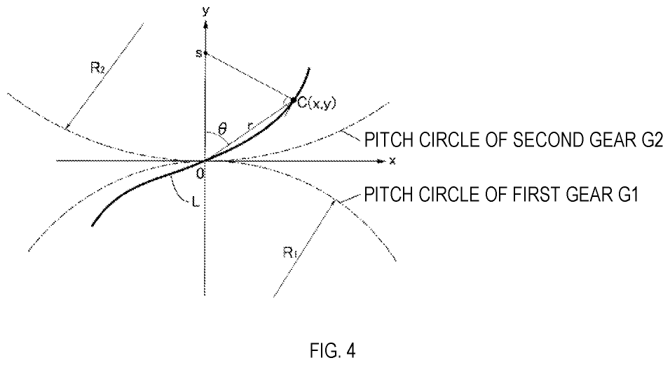

Here, as shown in FIG. 4, in an xy-coordinate system where the pitch point Pp of the first and second gears G1, G2 on the meshing line L is the origin, and a common tangent and a common normal of the pitch circles of the two gears G1, G2 are respectively an x-axis and a y-axis, it is assumed that a coordinate of a specific meshing point C is (x, y), a straight line length that connects the meshing point C and the origin (pitch point) is r, an acute angle of intersection with the y-axis of the straight line is θ, and pitch circle radii of the first and second gears G1, G2 are respectively R₁ and R₂. Then, the relative curvature κ of the tooth profile curves of the first and second gears G1, G2 at the meshing point C can be expressed as the following Formula (1) from the Eular-Savary formula, which is conventionally known with respect to relative curvatures.

$$\begin{matrix}[ Formula 1 ] & \\ κ = \frac{( {R}_{⊥} + {R}_{2} ) cos θ}{{r}^{2} ( \frac{{R}_{⊥}}{s} + 1 ) ( \frac{{R}_{2}}{s} - 1 )} & ( 1 )\end{matrix}$$

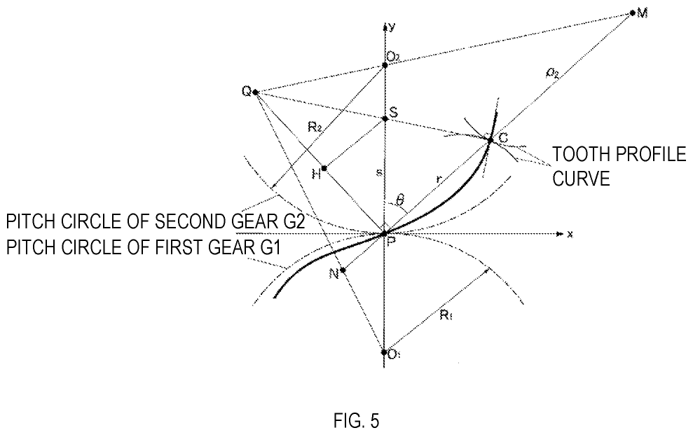

Referring to FIG. 5, a process for deriving this Formula (1) will be described. Similar to FIG. 4, FIG. 5 shows the meshing line L in an xy-coordinate system, and a point C is a meshing point (corresponding to the meshing point C in FIG. 4). It is assumed that, as a straight line CP moves in accordance with the meshing of the first and second gears G1, G2, the point C draws the meshing line L, and draws a tooth profile curve for the second gear G2.

In this case, an instant center of the second gear G2 in the xy-coordinate system coincides with a rotation center O₂ of the second gear G2. Also, a direction of movement of the straight line CP at the point C is a direction of a tangent at the point C on the meshing line L, while the direction of movement at a point P that follows the point C is a direction of the straight line CP. Accordingly, as is clear from FIG. 5, an instant center Q of the straight line CP in the xy-coordinate system is a point where a normal of the meshing line L at the point C intersects a normal to the straight line CP at the point P.

According to the well-known Kennedy's theorem, the instant center of the straight line CP with respect to the second gear G2 exists on an extension line of a straight line that connects the instant center O₂ of the second gear G2 in the xy-coordinate system and the instant center Q of the straight line CP in the xy-coordinate system. Moreover, meshing between tooth surfaces at the point C is regarded as a rolling movement at the point C. Therefore, the instant center of the straight line CP with respect to the second gear G2 exists on the extension line of the straight line CP. Accordingly, an intersection of the two extension lines is an instant center M of the straight line CP with respect to the second gear G2.

In FIG. 5 described above, when it is assumed that an intersection of a straight line CQ and the y-axis is S, an intersection of a straight line drawn parallel to the straight line CP from S and a straight line PQ is H, and a y-coordinate at the point S is s, a straight line SH is parallel to the straight line CP, and thus SH/CP=QS/QC. Then, the following Formula (2) is obtained.

$$\begin{matrix}[ Formula 2 ] & \\ PS \cdot ( cos θ ) / CP = QS / QC & ( 2 )\end{matrix}$$

On the other hand, by applying the Menelaus' theorem to a triangle SCP, the following Formula (3) is derived.

$$\begin{matrix}[ Formula 3 ] & \\ \frac{{SO}_{2}}{{O}_{2} P} \cdot \frac{PM}{MC} \cdot \frac{CQ}{QS} = 1 & ( 3 )\end{matrix}$$

Here, a length of a straight line O₂P corresponds to R₂, a length of a straight line PS corresponds to s, a length of the straight line CP corresponds to r, a length of a straight line CM corresponds to a curvature radius ρ₂ of the tooth profile curve of the second gear G2 at the point C, and a length of a straight line PM corresponds to a sum of p₂ and r. Accordingly, by substituting the relationship of these lengths and Formula (2) into Formula (3) and simplifying the substituted formula (3), the following Formula (4) can be obtained.

$$\begin{matrix}[ Formula 4 ] & \\ \frac{1}{{ρ}_{2}} = \frac{{sR}_{2} cos θ}{{r}^{2} ( {R}_{2} - s )} - \frac{1}{r} & ( 4 )\end{matrix}$$

Formula (4) represents a curvature 1/ρ₂ of the tooth profile curve of the second gear G2 at the point C.

With respect to the first gear G1 as well, similarly to above, the instant center of the straight line CP with respect to the first gear G1 is N in FIG. 5. If it is assumed that the curvature radius of the tooth profile curve of the first gear G1 at the point C is ρ₁, similarly to above, the following Formula (5) is derived.

$$\begin{matrix}[ Formula 5 ] & \\ \frac{1}{{ρ}_{⊥}} = \frac{- {sR}_{⊥} cos θ}{{r}^{2} ( {R}_{⊥} + s )} + \frac{1}{r} & ( 5 )\end{matrix}$$

Formula (5) represents a curvature 1/ρ₁ of the tooth profile curve of the first gear G1 at the point C.

Thus, since the relative curvature κ of the tooth profile curves of the first and second gears G1, G2 at the meshing point C is defined as a sum of the curvatures 1/ρ₁ and 1/ρ₂ of the respective tooth profile curves at the meshing point C as above, the aforementioned Formula (1) is derived by adding Formulas (4) and (5) and simplifying the formula obtained.

By substituting the following formulas to the Eular-Savary formula (1) obtained through the above derivation process, and simplifying the formula, the relative curvature κ is represented by the following Formula (6).

$$r = ( {x}^{2} + {y}^{2} ) \\ cos θ = \vert y \vert / r$$

$$\begin{matrix}[ Formula 6 ] & \\ κ = \frac{( {R}_{⊥} + {R}_{2} ) y}{{( {x}^{2} + {y}^{2} )}^{\frac{3}{2}} ( \frac{{R}_{⊥}}{s} + 1 ) ( \frac{{R}_{2}}{s} - 1 )} & ( 6 )\end{matrix}$$

Thus, in the first embodiment, a relational expression in which the relative curvature κ in the section of the meshing line L from the pitch point Pp to the end point Pe2 on the tooth-top side of the first gear G1 is smaller or equal to the maximum value of the relative curvature κ in the section from the pitch point Pp to the end point Pe1 on the tooth-root side of the first gear G1 is represented by the following Formula (7).

$$\begin{matrix}[ Formula 7 ] & \\ {κ}_{r} \geq {κ}_{t} \to \frac{{y}_{r}}{{( {x}_{r}^{2} + {y}_{r}^{2} )}^{\frac{3}{2}} ( \frac{{R}_{⊥}}{{s}_{r}} + 1 ) ( \frac{{R}_{2}}{{s}_{r}} - 1 )} \geq \frac{{y}_{t}}{{( {x}_{t}^{2} + {y}_{t}^{2} )}^{\frac{3}{2}} ( \frac{{R}_{⊥}}{{s}_{t}} + 1 ) ( \frac{{R}_{2}}{{s}_{t}} - 1 )} & ( 7 )\end{matrix}$$

In Formula (7), with the first gear G1 as a reference, a point with the maximum relative curvature κ in the section of the meshing line L on the tooth-top side from the pitch point Pp is Cₜ, and the relative curvature at the point Cₜ is κₜ, and a point with the maximum relative curvature κ in the section on the tooth-root side from the pitch point Pp is Cᵣ and the relative curvature at the point Cᵣ is κᵣ. Specifically, the aforementioned relational expression is represented as κᵣ≥κₜ. Also in Formula (7), a coordinate at the point Cₜ is (xₜ, yₜ) and a coordinate at the point Cᵣ is (xᵣ, yᵣ). Similar to FIG. 5, a y-coordinate of an intersection of a straight line CₜQ and the y-axis is sₜ and a y-coordinate of an intersection of a straight line CᵣQ and the y-axis is sᵣ.

In the gear pair of the first embodiment, in an entire region of the meshing line L, the pressure angle α is set to be greater than 0 degrees (preferably, 10 degrees or more). Also, as is clear from part (B) of FIG. 1, in the entire region of the meshing line L, the pressure angle α is changing constantly or continuously. There are no points where the curvature diverges on the tooth profile curve.

A thick solid line in part (C) of FIG. 1 shows how a value obtained by differentiating the curvature of the tooth profile curve of the first gear G1 by the meshing line length (that is, a curvature differential value) changes in accordance with the meshing line length. According to this, it can be seen that the curvature differential value is not constant in the entire region of the tooth profile curve, that is, constantly changes. Although not shown in the figure, since the first and second gears G1, G2 share the meshing line L, a value obtained by differentiating the curvature of the tooth profile curve of the second gear G2 by the meshing line length is similarly not constant in the entire region of the tooth profile curve, that is, constantly changes.

A thick dotted line in part (C) of FIG. 1 shows how the relative curvature of the tooth profile curve changes in accordance with the meshing line length. Here, “relative curvature” is defined as a sum of a curvature of a tooth profile curve of one tooth and a curvature of a tooth profile curve of the other tooth at the contact point of the teeth that mesh with each other, as described above. The smaller the relative curvature is, the lower the contact stress at the meshing point tends to be, and the higher the tooth surface strength tends to be.

### Second Embodiment

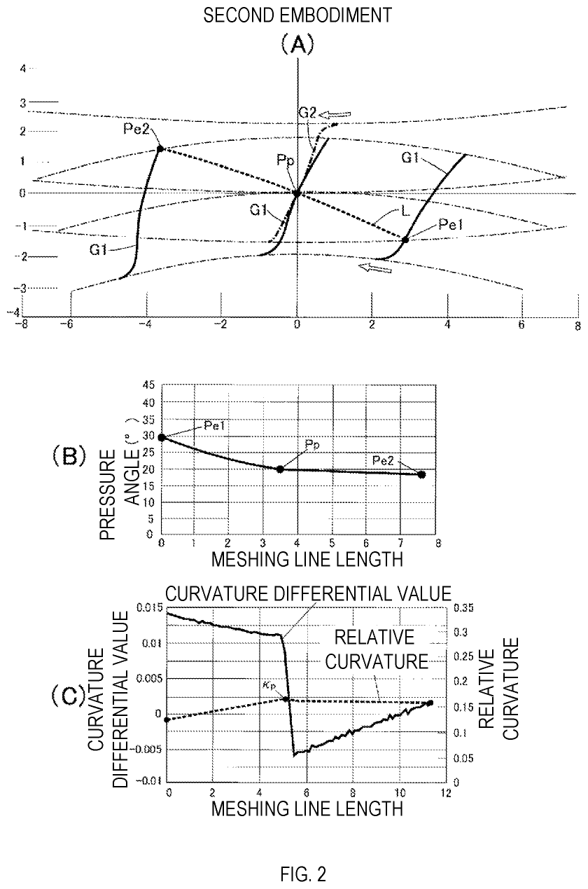

Next, a gear pair of the second embodiment will be described with reference to FIG. 2.

In the gear pair of the second embodiment as well, first and second gears G1, G2 rotate in an engaged manner, and along with the rotation, the meshing point of the teeth that mesh with each other moves continuously. A movement trajectory, that is, the meshing line Lis a smooth curve as shown in a thick dotted line in part (A) of FIG. 2. Specifically, the meshing line L of the first and second gears G1, G2 is not a straight line, and the first and second gears G1, G2 are not involute gears. In the second embodiment as well, teeth of the first and second gears G1, G2 that mesh with each other share the meshing line L.

In the second embodiment, the mode of change of the pressure angle α with respect to the meshing line length is shown by a thick solid line in part (B) of FIG. 2. A thick solid line in part (C) of FIG. 2 shows how a curvature differential value obtained by differentiating the curvature of the tooth profile curve of the first gear G1 by the meshing line length changes with the meshing line length. Further, a thick dotted line in part (C) of FIG. 2 shows how the relative curvature of the tooth profile curve changes with the meshing line length.

In the second embodiment, as is clear from part (B) of FIG. 2, the pressure angle α increases in the section of the meshing line L from the pitch point Pp to the end point Pe1 on the tooth-root side of the first gear G1 and slightly decreases in the section from the pitch point Pp to the end point Pe2 on the tooth-top side of the first gear G1.

Then, as is clear from part (C) of FIG. 2, as the tooth profile curves of the first and second gears G1, G2 of the second embodiment approach to the pitch point Pp from the end point Pe1 on the tooth-root side of the first gear G1 on the meshing line L, the relative curvature κ increases gradually, and the relative curvature κₚ is the maximum at the pitch point Pp. Also, in the section from the pitch point Pp to the end point Pe2 on the tooth-top side of the first gear G1, the relative curvature κ is slightly reduced. Specifically, the relative curvature κ in the section of the meshing line L from the pitch point Pp to the end point Pe2 on the tooth-top side of the first gear G1 is smaller than or equal to the maximum value of the relative curvature κ in the section from the pitch point Pp to the end point Pe1 on the tooth-root side of the first gear G1 (that is, the relative curvature κₚ at the pitch point Pp).

In the aforementioned xy-coordinate system (see FIG. 4), the relative curvature κ of the tooth profile curves of the first and second gears G1, G2 is represented by the aforementioned Formula (6) based on the Eular-Savary formula (1). Particularly, the relative curvature κₚ at the pitch point Pp corresponds to a limit value of the relative curvature κ represented by Formula (6) when x is brought as close to zero (0) as possible. Thus, the relative curvature κₚ can be represented by the following Formula (8).

$$\begin{matrix}[ Formula 8 ] & \\ {κ}_{p} = ( {R}_{1} + {R}_{2} ) \cdot {lim}_{x \to 0} \frac{y}{{( {x}^{2} + {y}^{2} )}^{\frac{3}{2}} ( \frac{{R}_{⊥}}{s} + 1 ) ( \frac{{R}_{2}}{s} - 1 )} & ( 8 )\end{matrix}$$

Thus, in the second embodiment, the relational expression where the relative curvature κ in the section of the meshing line L from the pitch point Pp to the end point Pe2 on the tooth-top side of the first gear G1 is smaller than or equal to the maximum value of the relative curvature κ in the section from the pitch point Pp to the end point Pe1 on the tooth-root side of the first gear G1 (that is, the relative curvature κₚ at the pitch point Pp) can be represented as the following Formula (9).

$$\begin{matrix}[ Formula 9 ] & \\ {κ}_{r} \geq {κ}_{t} ← \to {lim}_{x \to 0} \frac{{y}_{r}}{{( {x}^{2} + {y}^{2} )}^{\frac{3}{2}} ( \frac{{R}_{1}}{{s}_{r}} + 1 ) ( \frac{{R}_{2}}{{s}_{r}} - 1 )} \geq \frac{{y}_{t}}{{( {x}_{t}^{2} + {y}_{t}^{2} )}^{\frac{3}{2}} ( \frac{{R}_{1}}{{s}_{t}} + 1 ) ( \frac{{R}_{2}}{{s}_{t}} - 1 )} & ( 9 ) ←\end{matrix}$$

In Formula (9), with the first gear G1 as a reference, a point with the maximum relative curvature κ in the section of the meshing line L on the tooth-top side from the pitch point Pp is Cₜ and the relative curvature at the point Cₜ is κₜ, and the relative curvature κ at the pitch point Pp is κₚ. Specifically, the aforementioned relational expression can be represented by κₚ≥κₜ. Also in Formula (9), a coordinate of the point Cₜ is (xₜ, yₜ), and, similar to FIG. 5, a y-coordinate of an intersection of a straight line CₜQ and the y-axis is sₜ.

### Third Embodiment

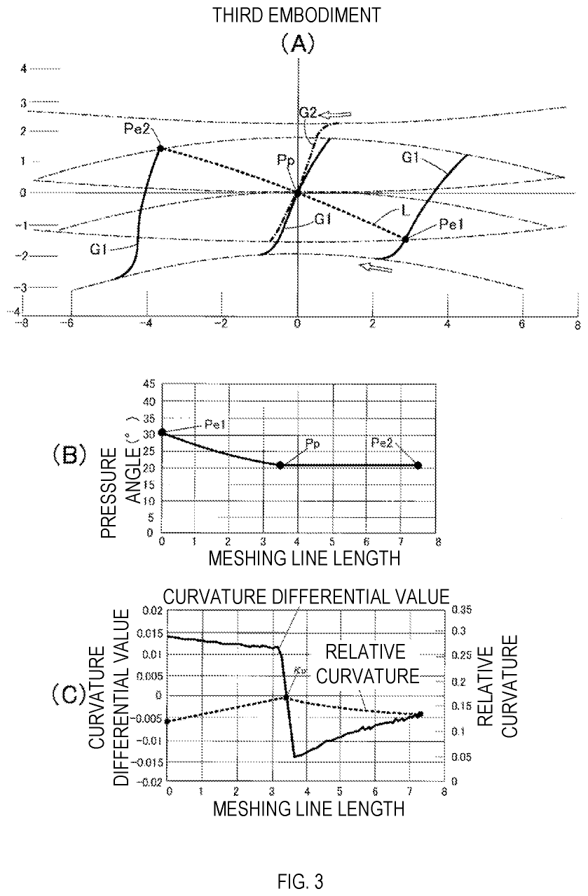

Next, a gear pair of the third embodiment will be described with reference to FIG. 3.

In the gear pair of the third embodiment as well, first and second gears G1, G2 rotate in an engaged manner, and along with the rotation, the meshing point of the teeth that mesh with each other moves continuously. A movement trajectory, that is, the meshing line Lis a smooth curve as shown in a thick dotted line in part (A) of FIG. 3. Specifically, the meshing line L of the first and second gears G1, G2 is not a straight line, and the first and second gears G1, G2 are not involute gears. In the third embodiment as well, teeth of the first and second gears G1, G2 that mesh with each other share the meshing line L.

In the third embodiment, the mode of change of the pressure angle α with respect to the meshing line length is shown by a thick solid line in part (B) of FIG. 3. A thick solid line in part (C) of FIG. 3 shows how a curvature differential value obtained by differentiating the curvature of the tooth profile curve of the first gear G1 by the meshing line length changes with the meshing line length. Further, a thick dotted line in part (C) of FIG. 3 shows how the relative curvature of the tooth profile curve changes with the meshing line length.

In the third embodiment, as is clear from part (B) of FIG. 3, the pressure angle α increases in the section of the meshing line L from the pitch point Pp to the end point Pe1 on the tooth-root side of the first gear G1 and is constant in the section from the pitch point Pp to the end point Pe2 on the tooth-top side of the first gear G1.

Then, as is clear from part (C) of FIG. 3, as the tooth profile curves of the first and second gears G1, G2 of the third embodiment approach to the pitch point Pp from the end point Pe1 on the tooth-root side of the first gear G1 on the meshing line L, the relative curvature κ increases gradually, and the relative curvature κₚ is the maximum at the pitch point Pp. Also, in the section from the pitch point Pp to the end point Pe2 on the tooth-top side of the first gear G1, the relative curvature κ is reduced. Specifically, the relative curvature κ in the section of the meshing line L from the pitch point Pp to the end point Pe2 on the tooth-top side of the first gear G1 is smaller than or equal to the maximum value of the relative curvature κ in the section from the pitch point Pp to the end point Pe1 on the tooth-root side of the first gear G1 (that is, the relative curvature κₚ at the pitch point Pp).

In the aforementioned xy-coordinate system (see FIG. 4), the relative curvature κ of the tooth profile curves of the first and second gears G1, G2 is represented by the aforementioned Formula (6) based on the Eular-Savary formula. Particularly, since the relative curvature κₚ at the pitch point Pp corresponds to a limit value of the relative curvature κ represented by Formula (6) when x is brought as close to zero (0) as possible, the relative curvature κₚ can be represented by the aforementioned Formula (8).

Thus, in the third embodiment, the relational expression where the relative curvature κ in the section of the meshing line L from the pitch point Pp to the end point Pe2 on the tooth-top side of the first gear G1 is smaller than or equal to the maximum value of the relative curvature κ in the section from the pitch point Pp to the end point Pe1 on the tooth-root side of the first gear G1 (that is, the relative curvature κₚ at the pitch point Pp) can be represented as the aforementioned Formula (9).

Next, an action of the above-described gear pairs of the first to third embodiments will be described.

The tooth profile curves of the first and second gears G1, G2 of the respective embodiments can be calculated by a computer, for example, based on basic design data of the two gears G1, G2 (for example, the number of the teeth, the pitch circle radius, dedendum circle and addendum circle diameters, etc.) and data of the pressure angle α to be set at each meshing point on the meshing line L (see parts (B) of respective FIGS. 1 to 3) and the relative curvature κ (see parts (C) of respective FIGS. 1 to 3). The tooth profile curves can be uniquely determined from the calculation results. The first and second gears G1, G2 are formed by forging or precision machining based on the determined tooth profile curves.

In the gear pair of each of the first to third embodiments manufactured as above, the teeth that mesh with each other share the meshing line L. Accordingly, the first and second gears G1, G2 can achieve smooth meshing, and transmission efficiency can be increased. Moreover, at least a part of the meshing line L includes a region where the pressure angle α is not constant. Therefore, while the meshing line L is shared as described above, the pressure angle α of the two gears G1, G2 can be set to various modes of change in association with the meshing line L. As a result, both the desired properties (for example, tooth surface strength) in accordance with the setting, and smooth meshing can be achieved.

In the gear pair of each of the first to third embodiments, the pressure angle α weakly increases (more specifically, the pressure angle α is constant in the first embodiment, and increases in the second and third embodiments) in the section of the meshing line L from the pitch point Pp to the end point Pe1 on the tooth-root side of the first gear G1. This makes it possible to reduce the relative curvature and increase the tooth surface strength on the tooth-root side of the first gear G1. Moreover, since the tooth profile curve comes close to a negative curvature or has a negative curvature on the tooth-root side, the tooth profile becomes wider toward the tooth root. Thus, the bending strength can be increased. Accordingly, it is possible to effectively increase the strength on the tooth-root side of the gear having a small number of teeth (that is, the first gear G1) which is subject to a large load especially on the tooth-root side.

Especially in the gear pair of the first embodiment, while the pressure angle α in the section of the meshing line L from the pitch point Pp to the end point Pe1 on the tooth-root side of the first gear G1 is constant as in a case of involute gears, the pressure angle α in the section from the pitch point Pp to the end point Pe2 on the tooth-top side of the first gear G1 monotonically decreases. In the tooth profile curves of the first and second gears G1, G2, the relative curvature κ in the section of the meshing line L from the pitch point Pp to the end point Pe2 on the tooth-top side of the first gear G1 is smaller than or equal to the maximum value of the relative curvature κ in the section from the pitch point Pp to the end point Pe1 on the tooth-root side of the first gear G1. In other words, in case of the gear (for example, involute gear) having a constant pressure angle in the entire region of the meshing line, there is a surplus tooth surface strength on the tooth-top side as compared to that on the tooth-root side. On the other hand, by reducing the pressure angle on the tooth-top side (thus, increasing the relative curvature κ on the tooth-top side) of the gear having the small number of teeth (that is, the first gear G1) as in the gear pair of the first embodiment, the surplus tooth surface strength on the tooth-top side can be used to improve a meshing ratio

Also, in the first gear G1 of the first embodiment, by setting the relative curvature κ on the tooth-top side smaller than or equal to the maximum value of the relative curvature κ on the tooth-root side (that is, the relative curvature κr at the end point Pe1 on the tooth-root side), it is possible to keep the tooth surface strength of the first gear G1 on the tooth-top side from becoming too low (that is, to ensure that the tooth surface strength on the tooth-top side is greater than or equal to that on the tooth-root side). This makes it possible to increase the meshing ratio while simultaneously ensuring the required tooth surface strength on the tooth-top side. Particularly, the strength can be effectively increased by defining the pressure angle of the gear having the small number of the teeth (that is, the first gear G1) which is subject to a large load compared to the gear having the large number of the teeth (that is, the second gear G2).

In the gear pair of the second embodiment, while the pressure angle α in the section of the meshing line L from the pitch point Pp to the end point Pe1 on the tooth-root side of the first gear G1 monotonously increases, the pressure angle α in the section from the pitch point Pp to the end point Pe2 on the tooth-top side of the first gear G1 slightly decreases. In the tooth profile curves of the first and second gears G1, G2, the relative curvature κ in the section of the meshing line L from the pitch point Pp to the end point Pe2 on the tooth-top side of the first gear G1 is smaller than or equal to the maximum value of the relative curvature κ in the section from the pitch point Pp to the end point Pe1 on the tooth-root side of the first gear G1. In other words, it is possible to increase the meshing ratio by reducing the pressure angle α in the section on the tooth-top side while increasing the strength on the tooth-root side of the gear having the small number of teeth (that is, the first gear G1) which is subject to a large load by monotonously increasing the pressure angle α (thus, reducing the relative curvature κ). In addition, it is possible to keep the tooth surface strength on the tooth-top side from becoming too low (that is, to ensure that the tooth surface strength on the tooth-top side is greater than or equal to that on the pitch point Pp) by setting the relative curvature κ on the tooth-top side smaller than or equal to the maximum value of the relative curvature κ on the tooth-root side (that is, the relative curvature κₚ at the pitch point Pp). This makes it possible to increase the meshing ratio while simultaneously ensuring the required tooth surface strength on the tooth-root side and the tooth-top side.

In the gear pair of the third embodiment, while the pressure angle α in the section of the meshing line L from the pitch point Pp to the end point Pe1 on the tooth-root side of the first gear G1 monotonously increases, the pressure angle α in the section from the pitch point Pp to the end point Pe2 on the tooth-top side of the first gear G1 is constant. In the tooth profile curves of the first and second gears G1, G2, the relative curvature κ in the section of the meshing line L from the pitch point Pp to the end point Pe2 on the tooth-top side of the first gear G1 is smaller than or equal to the maximum value of the relative curvature κ in the section from the pitch point Pp to the end point Pe1 on the tooth-root side of the first gear G1. In other words, similar to the second embodiment, it is possible to increase the meshing ratio by setting the pressure angle α to be constant in the section on the tooth-top side while increasing the strength on the tooth-root side of the gear having the small number of teeth (that is, the first gear G1) which is subject to a large load by monotonously increasing the pressure angle α (thus, reducing the relative curvature κ). In addition, it is possible to keep the tooth surface strength on the tooth-top side from becoming too low (that is, to ensure that the tooth surface strength on the tooth-top side is greater than or equal to that on the pitch point Pp) by setting the relative curvature κ on the tooth-top side smaller than or equal to the maximum value of the relative curvature κ on the tooth-root side (that is, the relative curvature κₚ at the pitch point Pp). This makes it possible to increase the meshing ratio while simultaneously ensuring the required tooth surface strength on the tooth-root side and the tooth-top side.

In the gear pair of each of the first to third embodiments, the value obtained by differentiating the curvature of the tooth profile curve by the meshing line length constantly changes, as shown in parts (C) of respective FIGS. 1 to 3. Thus, the relative curvature at the meshing point of the teeth that mesh with each other also changes constantly during the meshing. By setting the tooth profile curve that alleviates the changes in meshing stiffness of tooth surfaces due to the changes in the number of meshing teeth (for example, by reducing a relative curvature κ of a one-tooth meshing region, and increasing the relative curvature κ of a two-teeth meshing region), it is possible to use tooth surface deformation due to Hertzian contact to cancel the change in meshing stiffness, and achieve uniform meshing stiffness over the entire tooth surface. Then, it is clear that the gear pair of the first to third embodiments differ from IP bevel gears or CORNUX (registered trademark) gears.

According to the gear pair of each of the first to third embodiments, the pressure angle is set to be greater than zero (0) degrees (preferably, 10 degrees or more) in the entire region of the meshing line L, as shown in parts (B) of respective FIGS. 1 to 3. This reduces the relative curvature κ at the meshing point of the teeth that mesh with each other on average and increases the tooth surface strength. Moreover, the pressure angle α changes continuously in the entire region of the meshing line L, and there is no point where the curvature diverges in the tooth profile curve, that is, there is no point where the surface pressure is infinite in theory. Thus, in this regard as well, the tooth surface strength is improved. Therefore, it is clear that the gear pair of the first to third embodiments differ from cycloid gears.

In the first to third embodiments described above, the first and second gears G1, G2 forming the gear pair are spur gears having the rotation axes parallel to each other. The first and second gears G1, G2 that form the gear pair of the present invention may be bevel gears having intersecting rotation axes. A pair of bevel gears (figures of the tooth profile are omitted) will be a gear pair of a fourth embodiment described below.

### Fourth Embodiment

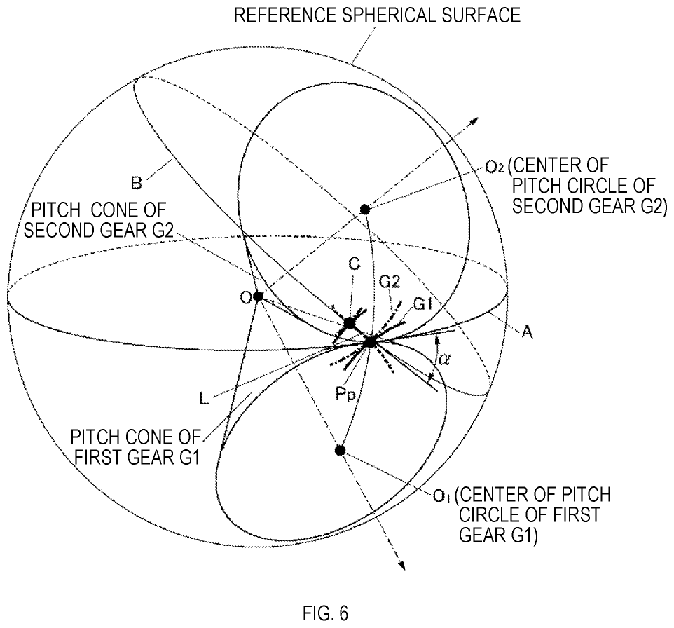

The bevel gear pair of the fourth embodiment has a spherical tooth profile, and the pressure angle is defined as below with reference to FIG. 6.

Specifically, it is assumed that a small diameter gear having a smaller number of teeth of the bevel gear pair is the first gear G1, and a large diameter gear having a larger number of teeth than the first gear G1 is the second gear G2. Further, it is assumed that, when a spherical surface including the meshing line L (thick dotted line in FIG. 6) is a reference spherical surface, a circle formed by cutting the reference spherical surface with a plane including a center O of the reference spherical surface and the pitch point Pp on the meshing line L is a pitch large circle A, and a circle formed by cutting the reference spherical surface with a plane tangent to the meshing line L at any meshing point C of the teeth that mesh with each other is a small circle B. On that assumption, an angle α of intersection on the acute angle side between the pitch large circle A and the small circle B is defined as a pressure angle at the meshing point C.

In the fourth embodiment as well, the tooth profile curves of the first and second gears G1, G2 are determined by the method according to the present invention similar to the method explained in the first to third embodiments, and the first and second gears G1, G2 are formed by forging based on the determined tooth profile curves. In this way, even if the first and second gears G1, G2 have complex spherical tooth profiles, the first and second gears G1, G2 can be relatively easily and accurately formed by forging.

As an example of the bevel gear pair according to the fourth embodiment, an embodiment is also possible in which a pinion gear formed by a bevel gear in a differential gear mechanism is the first gear G1, and a side gear formed by a bevel gear that meshes with the pinion gear is the second gear G2, for example.

Embodiments of the present invention have been explained above, but the present invention is not limited to the above-described embodiments and may be modified in a variety of ways as long as the modifications do not depart from the gist of the present invention.

For example, in the first to third embodiments, the first and second gears G1, G2 forming the gear pair are spur gears having the rotation axes parallel to each other. Alternatively, the first and second gears G1, G2 may be helical gears having rotation axes parallel to each other.

Some examples of the tooth profile curves of the first and second gears G1, G2 according to the present invention are shown in the first to third embodiments. Further, various tooth profile curves can be set without limitation to these examples. For example, settings as below are possible: (1) a tooth profile curve in which a concave surface on the tooth-root side and a convex surface on the tooth-top side are connected; (2) a tooth profile curve connecting from the concave surface on the tooth-root side to the convex surface on the tooth-top side via a specific transition zone; (3) a tooth profile curve extending from the concave surface on the tooth-root side to the tooth top in a straight line; (4) a tooth profile curve in which multiple patterns of transition zones are interposed between the concave surface on the tooth-root side and the convex surface on the tooth-top side; and so on. In any of the aforementioned tooth profile curves as well, the tooth profile curve is determined on a condition that the meshing line L of the teeth of the first and second gears G1, G2 that mesh with each other is shared and that at least a part of the meshing line L includes a region where the pressure angle α is not constant.

In the tooth profile curve having a spherical tooth profile of a bevel gear as in the fourth embodiment as well, similar to the aforementioned tooth profile patterns of the spur gear in the first to third embodiments, settings as below are possible, for example: (1) a tooth profile curve in which the concave surface on the tooth-root side and the convex surface on the tooth-top side are connected; (2) a tooth profile curve connecting from the concave surface on the tooth-root side to the convex surface on the tooth-top side via the specific transition zone; (3) a tooth profile curve extending from the concave surface on the tooth-root side to the tooth top in a straight line; (4) a tooth profile curve in which multiple patterns of transition zones are interposed between the concave surface on the tooth-root side and the convex surface on the tooth-top side; and so on.

1. A gear pair comprising:
a first gear and a second gear having a larger number of teeth than the first gear, the first gear and the second gear sharing a meshing line of teeth that mesh with each other, wherein
at least a part of the meshing line includes a region where a pressure angle is not constant,
the pressure angle monotonously decreases in a section of the meshing line from a pitch point to an end point on a tooth-top side of the first gear, and
a relative curvature of tooth profile curves of the first and second gears in the section of the meshing line from the pitch point to the end point on the tooth-top side of the first gear is smaller than or equal to a maximum value of the relative curvature in a section from the pitch point to an end point on a tooth-root side of the first gear.

2. The gear pair according to claim 1, wherein the pressure angle weakly increases in the section of the meshing line from the pitch point to the end point on the tooth-root side of the first gear.

3. A gear pair comprising:
a first gear and a second gear having a larger number of teeth than the first gear, the first gear and the second gear sharing a meshing line of teeth that mesh with each other, wherein
at least a part of the meshing line includes a region where a pressure angle is not constant,
the pressure angle is constant in a section of the meshing line from a pitch point to an end point on a tooth-top side of the first gear, and the pressure angle monotonously increases in a section of the meshing line from the pitch point to an end point on a tooth-root side of the first gear, and
a relative curvature of tooth profile curves of the first and second gears in the section of the meshing line from the pitch point to the end point on the tooth-top side of the first gear is smaller than or equal to a maximum value of the relative curvature in the section from the pitch point to the end point on the tooth-root side of the first gear.

4. The gear pair according to claim 3, wherein a value obtained by differentiating a curvature of a tooth profile curve by a meshing line length constantly changes in an entire region of the meshing line.

5. The gear pair according to claim 3, wherein the pressure angle is greater than zero degrees in an entire region of the meshing line.

6. The gear pair according to claim 3, wherein the first and second gears are forged bevel gears.

7. The gear pair according to claim 1, wherein a value obtained by differentiating a curvature of a tooth profile curve by a meshing line length constantly changes in an entire region of the meshing line.

8. The gear pair according to claim 1, wherein the pressure angle is greater than zero degrees in an entire region of the meshing line.

9. The gear pair according to claim 1, wherein the first and second gears are forged bevel gears.
